(19) United States
(12) Patent Application Publication
(10) Pub. No.: US 2025/0369495 A1
(43) Pub. Date: Dec. 4, 2025

(54) VENTILATED BRAKE DISC

(71) Applicant: SUBARU CORPORATION, Tokyo (JP)

(72) Inventors: Atsushi SHIOMITSU, Tokyo (JP); Koichi UCHIKAWA, Tokyo (JP)

(73) Assignee: SUBARU CORPORATION, Tokyo (JP)

(21) Appl. No.: 19/225,971

(22) Filed: Jun. 2, 2025

(30) Foreign Application Priority Data
Jun. 3, 2024 (JP) 2024-090138

(51) Int. Cl. F16D 65/12; F16D 65/02; F16D 65/78; F16D 65/847

(52) U.S. Cl. CPC F16D 65/128; F16D 65/847; F16D 2065/1328; F16D 2065/788

(57) ABSTRACT

A ventilated brake disc includes: a disc including two disc-shaped metal plates that are inner and outer plates disposed so as to face each other; an attachment member to a vehicle body; coupling ribs extending in a radial direction, and coupling facing surfaces of the inner plate and the outer plate that face each other; and a first circumferential rib provided in a region near an outer edge in a radial direction on one of the facing surfaces, protruding from a plate surface of the outer plate or the inner plate in a direction along a rotation axis of the disc toward the one of the facing surfaces, having a gap with the plate surface of the inner or outer plate, and continuously provided in an annular shape in a circumferential direction on the plate surface of the outer plate or the inner plate.

### CROSS-REFERENCE TO RELATED APPLICATIONS

The present application claims priority from Japanese Patent Application No. 2024-090138 filed on Jun. 3, 2024, the entire contents of which are hereby incorporated by reference.

### BACKGROUND OF THE INVENTION

### Field of the Invention

The disclosure relates to a ventilated brake disc used in a disc brake apparatus for a vehicle such as an automobile, and relates to, for example, a structure of the brake disc capable of suppressing in-plane vibration.

### Description of Background Art

Japanese Unexamined Patent Application Publication (JP-A) No. 2005-30471 and JP-A No. 2021-514449 describe brake discs. The entire contents of these publications are hereby incorporated by reference.

### SUMMARY OF THE INVENTION

According to one aspect of the present invention, a ventilated brake disc includes a disc including two disc-shaped metal plates including an inner plate and an outer plate facing each other, an attachment member that attaches the disc to a vehicle body, coupling ribs that are extending in a radial direction and that couple respective facing surfaces of the inner plate and the outer plate such that the facing surfaces face each other, and a circumferential rib positioned in a region near an outer edge in a radial direction on one of the facing surfaces and protruding from a plate surface of the outer plate or the inner plate in a direction along a rotation axis of the disc toward the one of the facing surfaces. The circumferential rib has a gap with the plate surface of the inner plate or the outer plate and is continuously formed in an annular shape in a circumferential direction on the plate surface of the outer plate or the inner plate.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic perspective view illustrating a ventilated brake disc according to an embodiment of the disclosure;

FIG. 2 is a plan view as viewed from a direction of an arrow 2 of FIG. 1;

FIG. 3 is a cross-sectional view taken along a line 3-3 of FIG. 2;

FIG. 4 is an enlarged cross-sectional view of a main part illustrating a region indicated by a reference sign 4 of FIG. 3 in an enlarged manner;

FIG. 5 is a cross-sectional view of a ventilated brake disc according to an embodiment of the disclosure;

FIG. 6 is an enlarged cross-sectional view of a main part illustrating a region indicated by a reference sign 6 of FIG. 5 in an enlarged manner;

FIG. 7 is a schematic perspective view illustrating a ventilated brake disc according to an embodiment of the disclosure;

FIG. 8 is a cross-sectional view taken along a line 8-8 of FIG. 7; and

FIG. 9 is a view illustrating modifications of cross-sectional shapes of first and second circumferential ribs in the ventilated brake discs of the embodiments of the disclosure.

### DETAILED DESCRIPTION OF THE EMBODIMENTS

Embodiments will now be described with reference to the accompanying drawings, wherein like reference numerals designate corresponding or identical elements throughout the various drawings.

Each drawing used in the following description is schematically illustrated. Therefore, in each drawing, each component is illustrated in a size that can be recognized on the drawing. For this reason, dimensional relationships, scales, and the like of the members in the drawings may be illustrated differently for each component. The disclosure is not limited to the illustrated form with respect to each quantity, each shape, each size ratio, each relative positional relationship, and the like of each component described in each drawing.

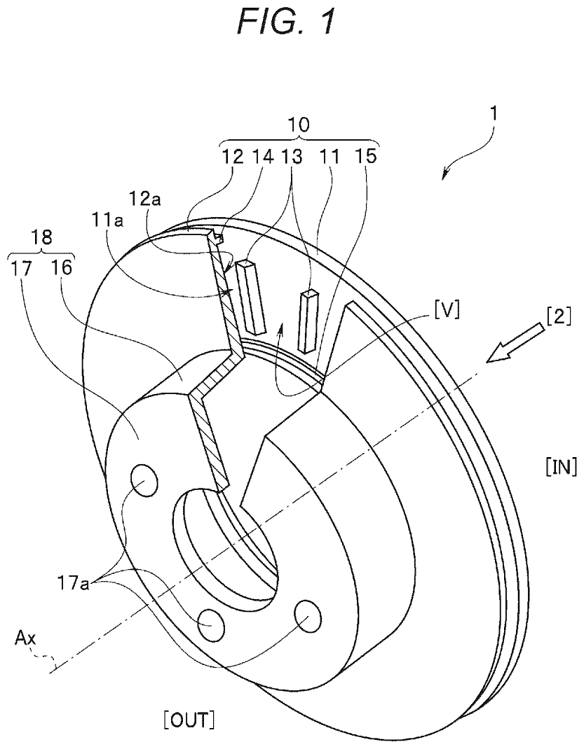

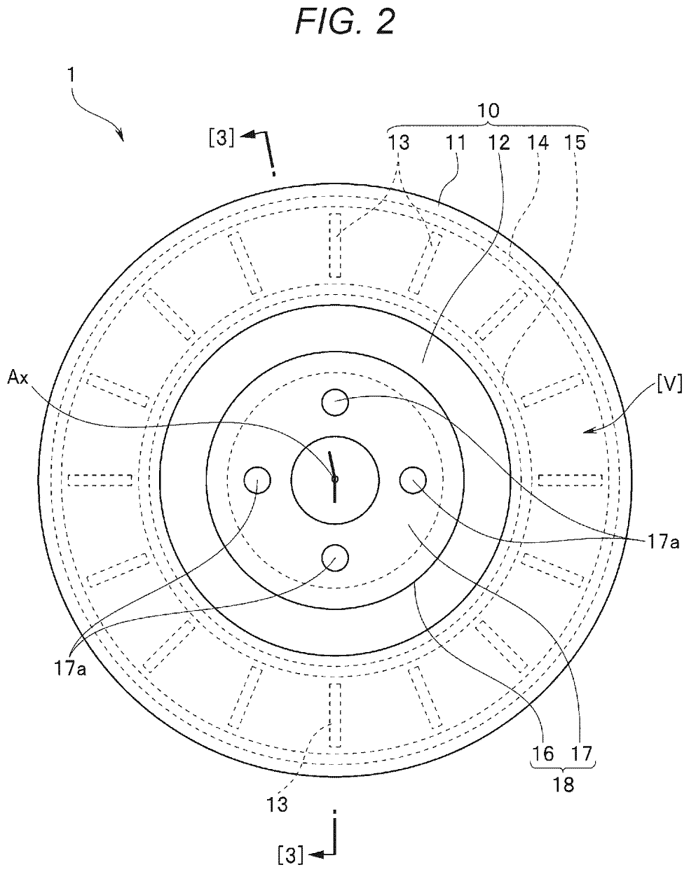

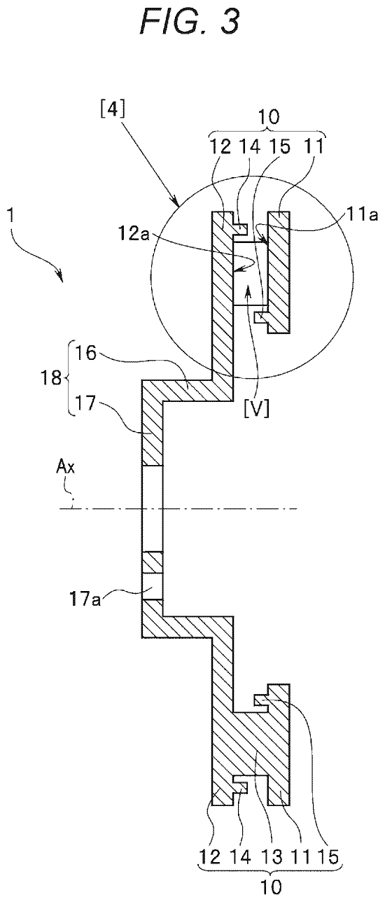

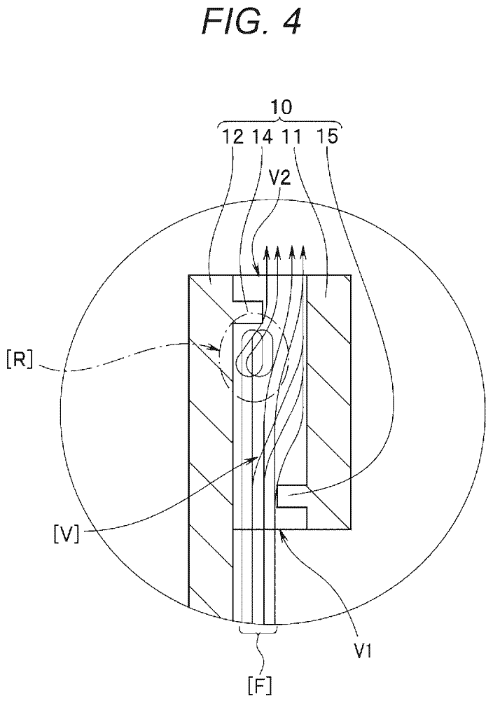

FIG. 1 is a schematic perspective view illustrating a ventilated brake disc according to a first embodiment of the disclosure. In FIG. 1, a part of the ventilated brake disc is cut out. FIG. 2 is a plan view of the ventilated brake disc according to the present embodiment as viewed from a direction of an arrow 2 of FIG. 1. FIG. 3 is a cross-sectional view taken along a line 3-3 of FIG. 2. FIG. 4 is an enlarged cross-sectional view of a main part illustrating a region indicated by a reference sign 4 of FIG. 3 in an enlarged manner.

First, a schematic configuration of the ventilated brake disc (hereinafter, simply abbreviated as a brake disc) according to the present embodiment will be described below.

As illustrated in FIGS. 1 to 3 and the like, a brake disc 1 according to the present embodiment roughly includes a disc 10 and an attachment member 18. The disc 10 includes two disc-shaped metal plates disposed so as to face each other with a predetermined gap dimension.

Here, the two disc-shaped metal plates are an inner plate 11 and an outer plate 12. The inner plate 11 is the disc-shaped metal plate (plate) disposed inside a vehicle body. The outer plate 12 is the disc-shaped metal plate (plate) disposed outside the vehicle body.

In FIG. 1, a reference sign Ax indicates a rotation axis of the brake disc 1. In FIG. 1, a region indicated by a reference sign OUT is referred to as a vehicle body outside region, and a region indicated by a reference sign IN is referred to as a vehicle body inside region.

The inner plate 11 and the outer plate 12 of the disc 10 are permanently coupled by coupling ribs 13. In this case, the coupling ribs 13 are rib-shaped members that couple facing surfaces (11a, 12a) of the inner plate 11 and the outer plate 12.

In other words, the coupling ribs 13 are provided in a gap between the inner plate 11 and the outer plate 12 and are provided as coupling members for coupling the inner plate 11 and the outer plate 12. In this case, in the gap space between the inner plate 11 and the outer plate 12, a space through which air passes in a circumferential direction is included in a region between the adjacent coupling ribs 13 (a region indicated by a reference sign V of FIG. 1 and the like), which is a part where the coupling ribs 13 are not disposed. This region V is a flow passage through which air flows. Therefore, in the following description, the region V is referred to as a ventilated part.

The coupling ribs 13 extends in a radial direction (radiation direction) of the disc 10 (11, 12). The coupling ribs 13 are disposed side by side in the circumferential direction over substantially entire circumference on each of the facing surfaces (11a, 12a) of the disc 10 (11, 12).

With such a configuration, the coupling ribs 13 play a role of suppressing out-of-plane vibration by securing rigidity in the radial direction (radiation direction) of the disc 10 (11, 12).

The outer plate 12 further includes a first circumferential rib 14 at a predetermined position on the facing surface 12a. The first circumferential rib 14 is provided in a region near an outer edge on the facing surface 12a of the outer plate 12.

The first circumferential rib 14 protrudes inward (toward the facing surface 11a of the inner plate 11) in the direction along the rotation axis Ax from the facing surface 12a of the outer plate 12. In this case, the first circumferential rib 14 has a protrusion amount that does not reach the facing surface 11a of the inner plate 11. In other words, the first circumferential rib 14 has a proximal end side on the facing surface 12a of the outer plate 12, and a distal end side with a predetermined gap from the facing surface 11a of the inner plate 11. The first circumferential rib 14 has an annular shape continuous in a circumferential direction of the outer plate 12.

The inner plate 11 further includes a second circumferential rib 15 at a predetermined position on the facing surface 11a. The second circumferential rib 15 is provided in a region near an inner edge on the facing surface 11a of the inner plate 11.

The second circumferential rib 15 protrudes inward (toward the facing surface 12a of the outer plate 12) in the direction along the rotation axis Ax from the facing surface 11a of the inner plate 11. In this case, the second circumferential rib 15 has a protrusion amount that does not reach the facing surface 12a of the outer plate 12. In other words, the second circumferential rib 15 has a proximal end side on the facing surface 11a of the inner plate 11, and a distal end side with a predetermined gap from the facing surface 12a of the outer plate 12. The second circumferential rib 15 has an annular shape continuous in a circumferential direction of the inner plate 11.

On the other hand, the attachment member 18 includes a hat 16 and a flange 17. The hat 16 is a component disposed between the disc 10 and the flange 17 for coupling and permanently affixing the disc 10 and the flange 17. The hat 16 includes a cylindrical wall surface extending from an inner peripheral edge of the outer plate 12 toward the outside of the vehicle body in the direction parallel to the rotation axis Ax.

The flange 17 is a flat surface provided at a vehicle body outer end of the hat 16. The flange 17 is provided with bolt insertion holes 17a. The bolt insertion holes 17a are provided for inserting bolts (not illustrated) for attaching a wheel (not illustrated) coaxially with the brake disc 1.

In the brake disc 1 according to the present embodiment configured in this manner, air flowing through the ventilated part V is, for example, as illustrated in FIG. 4. Here, a reference sign F of FIG. 4 schematically indicates the flow of the air passing through the ventilated part V. In this case, the air passing through the ventilated part V flows from an inner diameter side to an outer diameter side of the brake disc 1.

Here, in the brake disc 1 according to the present embodiment, the ventilated part V is slightly narrowed since the second circumferential rib 15 is provided in the vicinity of an inflow port V1 (see FIG. 4) on the inner diameter side. On the other hand, the ventilated part V is slightly narrowed because the first circumferential rib 14 is provided in the vicinity of an outflow port V2 (see FIG. 4) on the outer diameter side.

In this case, the flow of the air passing through the ventilated part V from the inner diameter side to the outer diameter side is considered.

First, as illustrated in FIG. 4, the flow F of the air flowing into the ventilated part V from the inflow port V1 travels in the radial direction inside the ventilated part V and eventually reaches the first circumferential rib 14. After the flow F of the air collides with the first circumferential rib 14, the flow F of the air temporarily stagnates in a predetermined region (region indicated by a reference sign R of FIG. 4) in front of the first circumferential rib 14 and near the outer plate 12. Thereafter, the flow F of the air bypasses the first circumferential rib 14 and flows out to the outflow port V2.

Here, as described above, the flow F of the air traveling in the radial direction in the ventilated part V collides with the first circumferential rib 14 and stagnates in the partial region R of a flow path near the outer plate 12. Since the air F stagnated here retains heat, heat dissipation is slightly inhibited in this region R.

Since the outer plate 12 generally has a larger mass and a larger surface area than those of the inner plate 11, a heat storage capacity tends to be larger than that of the inner plate 11, and heat dissipation tends to be higher than that of the inner plate 11. This causes a thermal inclination phenomenon.

Therefore, in the brake disc 1 according to the present embodiment, as described above, the heat dissipation is slightly suppressed by stagnating the flow F of the air in the predetermined region R near the outer plate 12. As a result, unevenness of a temperature difference between the inner plate 11 and the outer plate 12 is reduced.

As described above, according to the first embodiment, the disc 10 is provided with, in addition to the coupling ribs 13, the circumferential ribs (14, 15) in the two disc-shaped metal plates (11, 12). By such a simple structure change, rigidity of circumferential vibration can be secured and a natural frequency in the circumferential direction can be greatly changed. Therefore, the natural frequency of in-plane vibration of the brake disc 1 can be separated from an abnormal noise generation frequency, and brake squeal can be suppressed.

The natural frequency of the out-of-plane vibration can also be adjusted by increasing or decreasing the number of coupling ribs 13. Therefore, according to the configuration according to the present embodiment, the natural frequency of the in-plane vibration and the natural frequency of the out-of-plane vibration can be easily set independently.

The first circumferential rib 14 is provided on the outer edge side of the outer plate 12, and the second circumferential rib 15 is provided on the inner edge side of the inner plate 11. With such a configuration, it is possible to contribute to improvement of the heat storage capacity of each of the two disc-shaped metal plates (11, 12) of the disc 10.

The two circumferential ribs (14, 15) are disposed at the alternate positions when viewing a cross section of the ventilated part V. In other words, the first circumferential rib 14 is provided on the outer edge side of the outer plate 12 that is one of the two plates, and the second circumferential rib 15 is provided on the inner edge side of the inner plate 11 that is the other one of the two plates. With this configuration, the flow path F of the air passing through the ventilated part V can be made longer. Therefore, with this configuration, it is possible to contribute to improvement of the heat dissipation.

When the air passes through the ventilated part V, the flow F of the air is stagnated in the predetermined region R near the outer plate 12. With this configuration, the heat dissipation of the outer plate 12 can be slightly suppressed, and the unevenness of the temperature difference between the outer plate 12 and the inner plate 11 can be reduced. Therefore, the thermal inclination phenomenon of the disc 10 can be suppressed.

In the first embodiment, the example in which the circumferential rib is provided in each of the inner plate 11 and the outer plate 12 has been described. However, the disclosure is not limited to this configuration example.

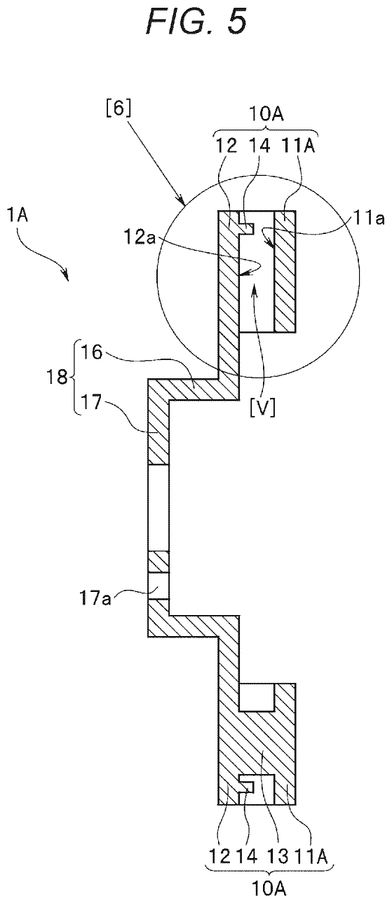

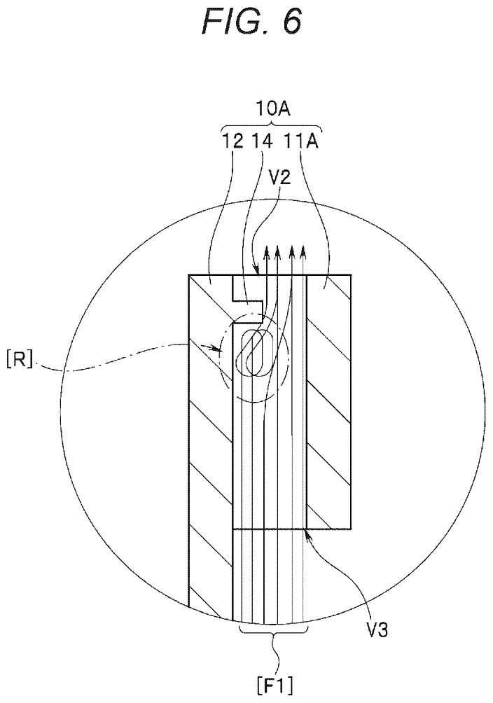

For example, a configuration example as in a second embodiment described below can also be considered. FIG. 5 is a cross-sectional view of a ventilated brake disc according to the second embodiment of the disclosure. FIG. 5 is a cross-sectional view corresponding to a cross section taken along a line corresponding to the line 3-3 of FIG. 2 in the present embodiment, similarly to FIG. 3. FIG. 6 is an enlarged cross-sectional view of a main part illustrating a region indicated by a reference sign 6 of FIG. 5 in an enlarged manner.

The second embodiment of the disclosure basically has substantially the same configuration as that of the first embodiment. In the present embodiment, a configuration of an inner plate 11A in a disc 10A of a brake disc 1A is slightly different. Therefore, in the following description, components similar to those of the first embodiment are denoted by the same reference signs, description thereof is omitted, and different parts will be described in detail below.

In the brake disc 1A according to the present embodiment, the disc 10A includes the inner plate 11A and an outer plate 12. The outer plate 12 is provided with a first circumferential rib 14 as in the first embodiment. On the other hand, in the present embodiment, the inner plate 11A is not provided with a second circumferential rib 15. Other configurations are similar to those of the first embodiment.

In the brake disc 1A according to the present embodiment configured in this manner, air flowing through a ventilated part V is, for example, as illustrated in FIG. 6. Here, a reference sign F1 of FIG. 6 schematically indicates the flow of the air passing through the ventilated part V. In this case, the air passing through the ventilated part V flows from an inner diameter side to an outer diameter side of the brake disc 1A, as in the first embodiment.

Here, in the brake disc 1A according to the present embodiment, the ventilated part V has an inflow port V3 (see FIG. 6) on the inner diameter side wider than that of the first embodiment by an amount corresponding to omission of the second circumferential rib 15. On the other hand, the ventilated part V has an outflow port V2 (see FIG. 6) on the outer diameter side slightly narrowed because the first circumferential rib 14 is provided, as in the first embodiment.

In this case, the flow of the air passing through the ventilated part V from the inner diameter side to the outer diameter side is considered.

First, as illustrated in FIG. 6, the flow F1 of the air flowing into the ventilated part V from the inflow port V3 travels in a radial direction inside the ventilated part V and eventually reaches the vicinity of the first circumferential rib 14. After a part of the flow F1 of the air collides with the first circumferential rib 14, the flow F1 of the air temporarily stagnates in a predetermined region (region indicated by a reference sign R of FIG. 6) in front of the first circumferential rib 14 and near the outer plate 12. Thereafter, the flow F1 of the air bypasses the first circumferential rib 14 and flows out to the outflow port V2.

The other part of the flow F1 of the air flowing in the ventilated part V directly travels straight to the outflow port V2 and flows out.

Here, as in the first embodiment, heat dissipation of the air F1 stagnated in the partial region R of a flow path near the outer plate 12 is slightly inhibited in the region R. As a result, also in the brake disc 1A according to the present embodiment, the heat dissipation is slightly suppressed by the stagnation of the flow F of the air in the predetermined region R near the outer plate 12. Therefore, unevenness of a temperature difference between the inner plate 11A and the outer plate 12 is reduced.

As described above, according to the second embodiment, the circumferential rib (14) is provided in one (outer plate 12) of the two disc-shaped metal plates (11A, 12) of the disc 10A. Also with this configuration, similar effects as those of the first embodiment can be obtained.

In the present embodiment, since the circumferential rib is not disposed on the inner plate 11A, a heat storage capacity on the inner plate 11A side can be slightly suppressed. Therefore, the unevenness of the temperature difference between the outer plate 12 and the inner plate 11A can be reduced, and a thermal inclination phenomenon of the disc 10A can be suppressed.

In the first and second embodiments, the form in which the inner peripheral edge of the outer plate 12 is coupled to the hat 16 is exemplified. In this configuration, in the first and second embodiments, the configuration example in which the first circumferential rib 14 is provided on the outer peripheral side of the outer plate 12 is indicated. In the first embodiment, the configuration example in which the second circumferential rib 15 is provided on the inner peripheral side of the inner plate 11 is further indicated.

However, the form of the ventilated brake disc is not limited to the configuration examples indicated in the first and second embodiments, and there are other forms. For example, in a ventilated brake disc indicated in the following third embodiment, an inner peripheral edge of an inner plate is coupled to a hat.

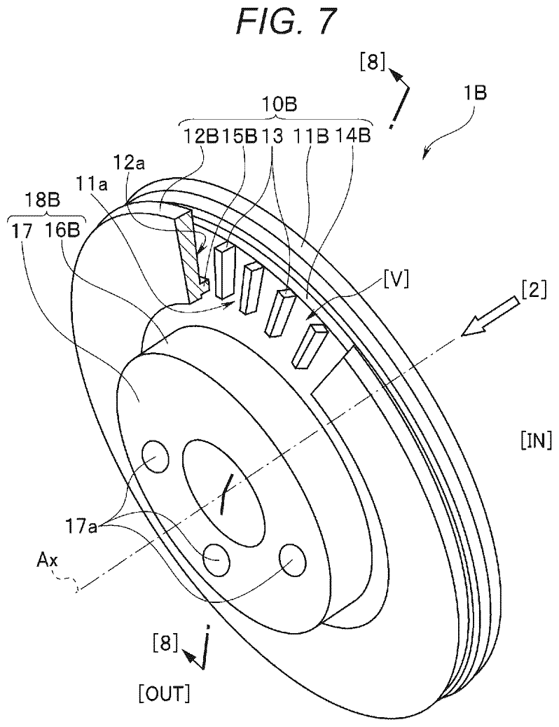

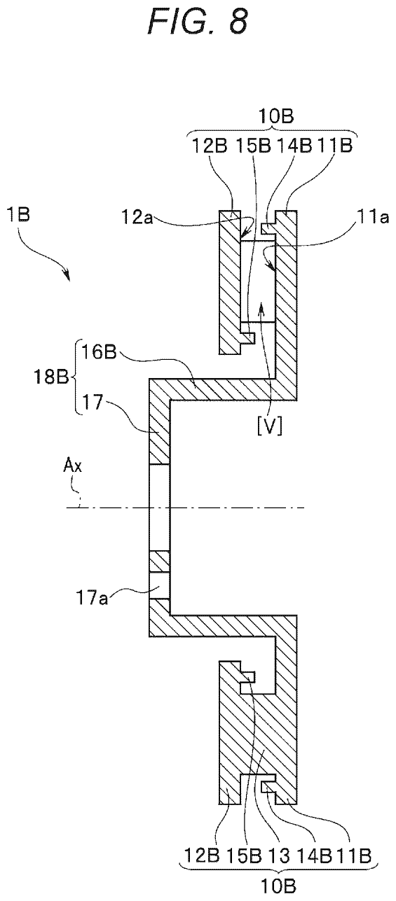

Hereinafter, the ventilated brake disc according to the third embodiment of the disclosure will be described. FIG. 7 is a schematic perspective view illustrating the ventilated brake disc according to the third embodiment of the disclosure. In FIG. 7, a part of the ventilated brake disc is cut out. FIG. 8 is a cross-sectional view taken along a line 8-8 of FIG. 7.

The brake disc of the third embodiment is different in that the inner peripheral edge of the inner plate is coupled to the hat. Therefore, configurations same as those of the first embodiment are denoted by the same reference signs, description thereof is omitted, and different configurations will be described in detail below.

As illustrated in FIGS. 7 and 8, a brake disc 1B according to the present embodiment roughly includes a disc 10B and an attachment member 18B, as in the first embodiment. The disc 10B includes two disc-shaped metal plates (an inner plate 11B and an outer plate 12B) disposed so as to face each other with a predetermined gap.

The inner plate 11B and the outer plate 12B are permanently coupled by coupling ribs 13 (coupling members).

Here, the outer plate 12B further includes a second circumferential rib 15B in a region near an inner edge on a facing surface 12a.

The second circumferential rib 15B protrudes inward (toward a facing surface 11a of the inner plate 11B) in a direction along a rotation axis Ax from the facing surface 12a of the outer plate 12B. In this case, the second circumferential rib 15B has a protrusion amount that does not reach the facing surface 11a of the inner plate 11B.

In other words, the second circumferential rib 15B has a proximal end on the facing surface 12a of the outer plate 12B, and a distal end with a predetermined gap from the facing surface 11a of the inner plate 11B. The second circumferential rib 15B has an annular shape continuous in a circumferential direction of the outer plate 12B.

The inner plate 11B further includes a first circumferential rib 14B in a region near an outer edge on the facing surface 11a.

The first circumferential rib 14B protrudes inward (toward the facing surface 12a of the outer plate 12B) in the direction along the rotation axis Ax from the facing surface 11a of the inner plate 11B. In this case, the first circumferential rib 14B has a protrusion amount that does not reach the facing surface 12a of the outer plate 12B. In other words, the first circumferential rib 14B has a proximal end on the facing surface 12a of the inner plate 11B, and a distal end with a predetermined gap from the facing surface 11a of the outer plate 12B. The first circumferential rib 14B has an annular shape continuous in a circumferential direction of the inner plate 11B.

On the other hand, the attachment member 18B includes a hat 16B and a flange 17. The hat 16B includes a cylindrical wall surface extending from an inner peripheral edge of the inner plate 11B toward the outside of a vehicle body in the direction parallel to the rotation axis Ax. Other configurations are substantially the same as those of the first embodiment.

In the brake disc 1B according to the present embodiment configured in this manner, although not illustrated, for example, air flowing through a ventilated part V collides with the first circumferential rib 14B and then temporarily stagnates in front of the first circumferential rib 14B, and thereafter, bypasses the first circumferential rib 14B and flows out to an outflow port, in substantially the same manner as that of the description made with reference to FIG. 4 and the like.

In the configuration according to the present embodiment, on the outer plate 12B side, cooling performance is higher. However, since an air flow path is longer, an outflow of the air is delayed. As a result, the outer plate 12B has a slightly higher temperature (medium temperature) than that of the inner plate 11B.

On the other hand, the inner plate 11B coupled to the hat 16B has a larger mass and a larger surface area than those of the outer plate 12B. Therefore, the inner plate 11B has a larger heat storage capacity and higher heat dissipation than those of the outer plate 12B. On the other hand, an air flow path is shortened. As a result, unevenness of a temperature difference between the inner plate 11B and the outer plate 12B is slightly suppressed.

In this manner, in the configuration of the third embodiment, as compared with the configurations of the first and second embodiments, the unevenness of the temperature difference between the inner plate 11B and the outer plate 12B can be slightly suppressed. However, even in the configuration of the third embodiment, a thermal inclination phenomenon may occur. In the case of this configuration, a thermal inclination phenomenon to the opposite side to the case of the configuration of the first embodiment occurs.

Therefore, in the brake disc 1B according to the present embodiment, the heat dissipation is slightly suppressed by stagnating the flow of the air in a predetermined region (in the vicinity of the first circumferential rib 14B) of the inner plate 11B. As a result, the unevenness of the temperature difference between the inner plate 11B and the outer plate 12B is reduced.

As described above, according to the third embodiment, even in the brake disc in the form (form in which the hat is coupled to the inner plate) different from the forms of the first and second embodiments (forms in which the hat is coupled to the outer plate), it is possible to obtain substantially the same effects as those of the first embodiment.

Cross-sectional shapes of the first circumferential ribs (14, 14B) or the second circumferential ribs (15, 15B) included in the ventilated brake discs of the first to third embodiments are not limited to the forms illustrated in FIGS. 3 to 6 and 8, such as rectangular cross sections or the like.

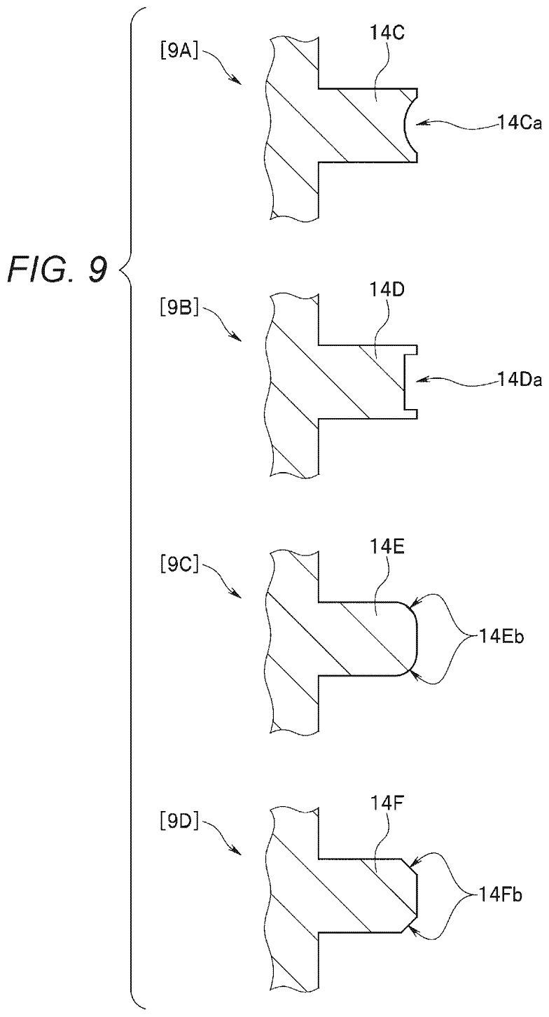

For example, various cross-sectional shapes as illustrated in FIG. 9 may be provided. Here, FIG. 9 is a view illustrating modifications of the cross-sectional shapes of the first and second circumferential ribs in the ventilated brake discs of the first to third embodiments of the disclosure.

In FIG. 9, various modifications (14C, 14D, 14E, and 14F) of the first circumferential ribs (14, 14B) are illustrated. However, each form can be applied similarly to the second circumferential ribs (15, 15B).

The first circumferential rib 14C of a first modification indicated by a reference sign 9A of FIG. 9 has a recess 14Ca in which a cross-sectional shape of a rib distal end surface is recessed in an arc shape.

The first circumferential rib 14D of a second modification indicated by a reference sign 9B of FIG. 9 has a recess 14Da in which a cross-sectional shape of a rib distal end surface is recessed in a rectangular shape.

In the first circumferential rib 14E of a third modification indicated by a reference sign 9C of FIG. 9, cross-sectional shapes of peripheral edge corners of a rib distal end surface are provided as R-shaped parts 14Eb.

In the first circumferential rib 14F of a fourth modification indicated by a reference sign 9D of FIG. 9, cross-sectional shapes of peripheral edge corners of a rib distal end surface are provided as C-chamfered parts 14Fb.

In each of the modifications of the reference signs 9C and 9D of FIG. 9, the R-shaped part 14Eb or the C-chamfered part 14Fb may be provided over entire circumference of the peripheral edge corner, or may be configured in various forms such as a form in which the R-shaped part 14Eb or the C-chamfered part 14Fb is provided on both or one of the outer peripheral side and the inner peripheral side of the peripheral edge corners in the disc radial direction (air flow path direction) (form in which the R-shaped part 14Eb or the C-chamfered part 14Fb is not provided on a rib side surface).

According to various forms of the first and second circumferential ribs provided in this manner, a degree of the flow of the air in the ventilated part V, a degree of the stagnation of the air in the partial region R in the vicinity of the first and second circumferential ribs, and the like can be changed.

Therefore, the flow of the air and the like in the ventilated part can be adjusted to a desired form by variously changing the cross-sectional shapes of the first and second circumferential ribs.

The disclosure is not limited to the embodiments described above, and various modifications and applications can be implemented without departing from the gist of the disclosure. The embodiments described above include the disclosure at various stages, and various types of disclosure can be extracted by appropriately combining disclosed constituent elements. For example, when a problem to be solved by the disclosure can be solved and the effects of the disclosure can be obtained even when some constituent elements are deleted from all the constituent elements described in each of the embodiments, the configuration from which the constituent elements are deleted can be extracted as the disclosure. The components of different embodiments may be appropriately combined. The disclosure is not limited by its specific implementations other than by the appended claims.

According to an embodiment of the disclosure, it is possible to provide a ventilated brake disc that can suppress abnormal noise such as brake squeal generated at the time of brake operation, contribute to improvement of heat storage and heat dissipation of a brake disc, and suppress occurrence of a thermal inclination phenomenon with a simple structure in a disc brake apparatus.

In recent years, as a brake apparatus used for a vehicle such as an automobile, for example, a disc brake apparatus has been put into practical use and widely spread. The disc brake apparatus sandwiches a plate surface of a metallic brake disc (also referred to as a brake rotor or a disc rotor) from both sides using a friction member. The brake disc is attached coaxially with a wheel and rotates together with the wheel. With this configuration, the disc brake apparatus suppresses rotation of the wheel, and decelerates or stops the vehicle.

In this type of disc brake apparatus, abnormal noise referred to as brake squeal may be generated when a brake is operated. It has been found that one cause of the generation of such abnormal noise in the brake apparatus is, for example, in-plane vibration of the brake disc (vibration in a circumferential direction of the disc).

Therefore, various techniques of adjusting or suppressing the generation of the abnormal noise during the operation of the brake in the brake apparatus by changing a shape of the brake disc are proposed in, for example, Japanese Unexamined Patent Application Publication (JP-A) No. 2005-30471 and JP-A No. 2021-514449.

In the technique described in JP-A No. 2005-30471 and the like, a natural frequency of the brake disc is measured, and when a result of the measurement does not fall within an allowable range, a part of the brake disc is cut. In this manner, the disc shape is changed, and the natural frequency of the in-plane vibration of the brake disc is adjusted so as to be separated from an abnormal noise generation frequency. As a result, generation of the abnormal noise such as the brake squeal is suppressed.

The brake disc described in JP-A No. 2021-514449 and the like is a ventilated brake disc. The ventilated brake disc has a configuration in which, for coupling ribs in a region of a predetermined range in a circumferential direction among coupling ribs coupling two plates constituting the brake disc and provided in a radial direction (radiation direction), adjacent coupling ribs are coupled to each other by a protrusion provided on one or both of the two plates and extending in the circumferential direction without coupling the two plates. In this manner, by providing the coupling ribs coupling the two plates and the protrusion coupling a part of the coupling ribs in the circumferential direction, generation of the abnormal noise such as the brake squeal is suppressed.

According to the techniques described in JP-A No. 2005-30471, JP-A No. 2021-514449, and the like, a mass and rigidity of the brake disc itself change with the change in the shape of the brake disc. Therefore, each natural frequency including the in-plane vibration changes. Therefore, in some cases, the in-plane vibration (vibration in the circumferential direction of the disc) and out-of-plane vibration (vibration that amplitudes in a direction along a rotation axis of the disc) are continuously generated, which may worsen the brake squeal.

In the disc brake apparatus, rotational energy of the rotating brake disc is converted into thermal energy by friction when a brake pad is pressed against the plate surface of the brake disc. Therefore, when the brake apparatus is operated by the thermal energy, heat is generated in the brake disc. However, when the brake disc rotates and comes into contact with outside air, the heat is dissipated and the brake disc is cooled. In this case, a brake effect is lowered unless sufficient heat dissipation is performed.

Therefore, in the disc brake apparatus, for example, a form referred to as the ventilated brake disc has been put into practical use as a device for efficiently dissipating heat.

For example, in the ventilated brake disc, two disc-shaped metal plates are disposed together, and ribs extending in the radial direction (radiation direction) and disposed side by side in the circumferential direction are used to couple the two discs. With such a configuration, a gap space between adjacent ribs is ventilated between the two discs. As a result, heat dissipation of the brake disc can be efficiently performed.

However, in this type of ventilated brake disc, a heat storage capacity is different between the two disc-shaped metal plates, which are an outer plate disposed outside a vehicle body and an inner plate disposed inside the vehicle body. A distortion amount on an outer peripheral side of the disc is different between the outer plate and the inner plate due to this.

For this reason, in the operating brake disc, a heat storage difference or a heat radiation difference between the inner plate and the outer plate may cause a so-called thermal inclination phenomenon in which the disc is distorted to be inclined in the direction along the rotation axis. When such a thermal inclination phenomenon occurs, for example, uneven wear of the brake pad may occur, and a judder phenomenon may occur.

Therefore, in the brake apparatus to which the ventilated brake disc is applied, for example, measures or structural devices for suppressing the thermal inclination phenomenon while securing more efficient heat dissipation is desired.

It is desirable to provide a ventilated brake disc that can suppress abnormal noise such as brake squeal generated at the time of brake operation, contribute to improvement of heat storage and heat dissipation of a brake disc, and suppress occurrence of a thermal inclination phenomenon with a simple structure in a disc brake apparatus.

An aspect of the disclosure provides a ventilated brake disc. The ventilated brake disc includes a disc, an attachment member, coupling ribs, and a first circumferential rib. The disc includes two disc-shaped metal plates that are an inner plate and an outer plate disposed so as to face each other. The attachment member is attached to a vehicle body. The coupling ribs extend in a radial direction and couple respective facing surfaces of the inner plate and the outer plate. The facing surfaces face each other. The first circumferential rib is provided in a region near an outer edge in a radial direction on one of the facing surfaces. The first circumferential rib protrudes from a plate surface of the outer plate or the inner plate in a direction along a rotation axis of the disc toward the one of the facing surfaces. The first circumferential rib has a gap with the plate surface of the inner plate or the outer plate. The first circumferential rib is continuously provided in an annular shape in a circumferential direction on the plate surface of the outer plate or the inner plate.

Obviously, numerous modifications and variations of the present invention are possible in light of the above teachings. It is therefore to be understood that within the scope of the appended claims, the invention may be practiced otherwise than as specifically described herein.

1. A ventilated brake disc, comprising:
a disc comprising two disc-shaped metal plates including an inner plate and an outer plate facing each other;
an attachment member configured to attach the disc to a vehicle body;
a plurality of coupling ribs extending in a radial direction and configured to couple respective facing surfaces of the inner plate and the outer plate such that the facing surfaces face each other; and
a circumferential rib positioned in a region near an outer edge in a radial direction on one of the facing surfaces and protruding from a plate surface of the outer plate or the inner plate in a direction along a rotation axis of the disc toward the one of the facing surfaces,
wherein the circumferential rib has a gap with the plate surface of the inner plate or the outer plate and is continuously formed in an annular shape in a circumferential direction on the plate surface of the outer plate or the inner plate.

2. The ventilated brake disc according to claim 1, further comprising:
a second circumferential rib positioned in a region near an inner edge in the radial direction on the one of the facing surfaces and protruding from the plate surface of the inner plate or the outer plate in the direction along the rotation axis of the disc toward the one of the facing surfaces, having a gap with the plate surface of the outer plate or the inner plate and continuously formed in an annular shape in the circumferential direction on the plate surface of the inner plate or the outer plate.

3. The ventilated brake disc according to claim 1, wherein each of the coupling ribs extends in the radial direction of the disc, and the coupling ribs are positioned side by side in the circumferential direction.

4. The ventilated brake disc according to claim 1, wherein the circumferential rib is configured to stagnate a part of a flow of air flowing in a gap space between the coupling ribs in a predetermined region between the outer plate and the inner plate.

5. The ventilated brake disc according to claim 2, wherein the second circumferential rib narrows a part of an inflow port of a flow of air flowing in a gap space between the coupling ribs between the outer plate and the inner plate.

6. The ventilated brake disc according to claim 2, wherein each of the coupling ribs extends in the radial direction of the disc, and the coupling ribs are positioned side by side in the circumferential direction.

7. The ventilated brake disc according to claim 2, wherein the circumferential rib is configured to stagnate a part of a flow of air flowing in a gap space between the coupling ribs in a predetermined region between the outer plate and the inner plate.

8. The ventilated brake disc according to claim 5, wherein the second circumferential rib narrows a part of an inflow port of a flow of air flowing in a gap space between the coupling ribs between the outer plate and the inner plate.

9. The ventilated brake disc according to claim 6, wherein the second circumferential rib narrows a part of an inflow port of a flow of air flowing in a gap space between the coupling ribs between the outer plate and the inner plate.

10. The ventilated brake disc according to claim 3, wherein the circumferential rib is configured to stagnate a part of a flow of air flowing in a gap space between the coupling ribs in a predetermined region between the outer plate and the inner plate.

11. The ventilated brake disc according to claim 6, wherein the circumferential rib is configured to stagnate a part of a flow of air flowing in a gap space between the coupling ribs in a predetermined region between the outer plate and the inner plate.

12. The ventilated brake disc according to claim 11, wherein the second circumferential rib narrows a part of an inflow port of a flow of air flowing in a gap space between the coupling ribs between the outer plate and the inner plate.
